(19) United States
(12) Patent Application Publication
(10) Pub. No.: US 2005/0047537 A1
(43) Pub. Date: Mar. 3, 2005

(54) Method and system of signal path tracking

(76) Inventor: Ting-Yuan Cheng, Guishan Township (TW)

Correspondence Address: RABIN & BERDO, P.C., Suite 500, 1101 14th Street, N.W., Washington, DC, 20005, US

(21) Appl. No.: 10/650,794

(22) Filed: Aug. 29, 2003

(51) Int. Cl. H04L 7/00

(52) U.S. Cl. 375/355

(57) ABSTRACT

A signal path tracking method and system for symbol timing recovery. In digital communication, a receiver requires a symbol sampler and a match filter to digitalize analog signals. The symbol sampler establishes on-time samples according to preset current sampling points. The present invention provides a method to improve synchronization between the receiver and the received signal by comparing the current sampling points with acquisition of maximum signal strength. The moving average of the timing difference is used to predict expected errors for future sampling points. The timing scheme is then adjusted according to the expected errors in order to generate future sampling points for sampling subsequent symbols precisely, thereby recovering the synchronization.

### BACKGROUND OF THE INVENTION

1. Field of the Invention

The present invention relates to symbol timing recovery, and more specifically, to a method and system of signal path tracking to recover synchronization between a receiver and a received signal.

2. Description of the Related Art

In digital receiving, sampling examines the received signal at specific times for symbol detection. The sampling process samples the received signal at a preset sampling rate, and each symbol may have more than one sample. The sampling process also includes establishing an on-time sample for each symbol. These on-time samples will be used to identify the symbols carried in the received signal. The on-time samples are best established when the signal has a highest signal to noise ratio (SNR) in every symbol duration. A match filter is usually included in the digital receiving system, in order to generate a peak signal strength which helps suppress effects of noise. The receiver needs to be synchronized with the receiving signal, and makes on-time samples at the optimal points. However, since the accuracy and stability of the clock reference in the receiver are not ideal, and the condition of transmission channel may vary significantly, this synchronization needs to be maintained. Sampling at the optimal points is very important because even a small offset in sampling point may cause significant errors.

Thus, the receiver requires a symbol timing recovery block to keep track of the received signal and determine the optimal points for symbol sampling. The symbol timing recovery block maintains synchronization by tracking the signal path and periodically adjusting the timing scheme for establishing on-time samples.

FIG. 1 is a block diagram showing a digital receiving system as disclosed. The receiver receives a signal by an antenna 102. A demodulator 104 receives the signal from the antenna 102, and demodulates the signal using a frequency identical to that used in the transmitter. The transmission channel may introduce a phase offset into the signal, and for that reason, a carrier recovery block 106 is usually required to remove the phase offset. This carrier recovery block 106 is usually implemented by a phase lock loop (PLL). A match filter 108 receives the signal from the demodulator 104. The match filter 108 is designed to match the shape of the signal, in order to generate a peak SNR for each symbol. The symbol sampler 110 receives and samples the matched signal. The symbol timing recovery block 112 checks and controls the sampling points. Data from the symbol sampler 110 is then recovered into digital data through quantization and un-mapping in block 114.

The conventional symbol timing recovery block 112 is usually a delay lock loop (DLL). FIG. 2 shows a simple block diagram for the delay lock loop with the symbol sampler. The symbol sampler 202 takes in samples at a preset rate, and the system also decides the number of samples per symbol. The symbol sampler 202 establishes an on-time sample according to a timing scheme. The DLL then checks the validity of the on-time sample, subtracting the previous sample (early sampling) 206 from the subsequent sample (late sampling) 208. Ideally, if the on-time sample peaks the match filter output, the early and late sampling are equal. Since this is rarely the case, differences between the early and late samplings are respectively multiplied by the on-time sampling value and added. When this sum exceeds a threshold, it is clear that the symbol sampler 202 is not sampling at an allowable duration for correct symbol detection. The offset decision 204 then adjusts the timing scheme to generate a more precise sampling point for the next symbol. This DLL system thus fixes the optimal points for sampling after a few trials.

Although the DDL system can recover the sampling points when tracking a single signal, the DDL system becomes less reliable and may not perform symbol timing recovery properly in the environment of clustered signal paths, since the early sampling and the late sampling will be seriously affected by the paths of other signals.

### SUMMARY OF THE INVENTION

The object of the present invention is to provide a method of signal path tracking for symbol timing recovery.

Another object of the present invention is to provide a method for symbol timing recovery which can track signal path in an environment of clustered signal paths.

In order to achieve these objects, the present invention provides a signal path tracking method and system for symbol timing recovery. The signal path tracking system includes a symbol sampler, which samples a received signal according to a timing scheme. Current sampling points are expected to establish on-time samples for current symbols. The symbol sampler samples at a preset sampling rate with a fixed number of samples per symbol. A peak detector receives the samples from the symbol sampler and outputs optimal points for establishing on-time samples of the current symbols. The peak detector determines the optimal point for each symbol by finding a sample with strongest SNR during the duration of each symbol, and outputs the corresponding time of the sample as the optimal point.

The current sampling points of the symbol sampler and the optimal points detected by the peak detector are input to an error detector. The error detector computes an expected error by calculating timing differences between the two inputs, filtering the timing differences to obtain an average moving error, and finally integrating the average moving error. The error detector outputs the expected error to a path tracker to predict a future sampling point of a subsequent symbol. The path tracker then feeds back the future sampling point to the symbol sampler to adjust the timing scheme, thereby recovering symbol timing of the receiver.

### BRIEF DESCRIPTION OF THE DRAWINGS

The present invention can be more fully understood by reading the subsequent detailed description in conjunction with the examples and references made to the accompanying drawings, wherein:

FIG. 1 is a block diagram showing a digital receiving system;

FIG. 2 is a block diagram showing a delayed locked loop (DLL) for symbol timing recovery;

FIG. 3 is a block diagram showing a first embodiment of the signal path tracking system of the present invention;

FIG. 4 is a signal-time graph showing the sampled signal;

FIG. 5A is a simple block diagram of the error detector in FIG. 3;

FIG. 5B is a logic circuit diagram of the error detector;

FIG. 6 is a block diagram showing a second embodiment of the signal path tracking system of the present invention;

FIG. 7 is a flowchart showing the signal path tracking method of the second embodiment;

FIG. 8 is a graph illustrating an example of the signal path tracking according to the second embodiment;

FIG. 9A is a graph showing the simulation result of a static signal;

FIG. 9B is a graph showing the simulation result of a dynamic signal;

FIG. 10A is a graph showing the average moving error of tracking the static signal in FIG. 9A;

FIG. 10B is a graph showing the average moving error of tracking the dynamic signal in FIG. 9B;

FIG. 11 is a graph showing the simulation result of two dynamic signals;

FIG. 12 is a graph showing the average moving error of tracking the two dynamic signals in FIG. 11.

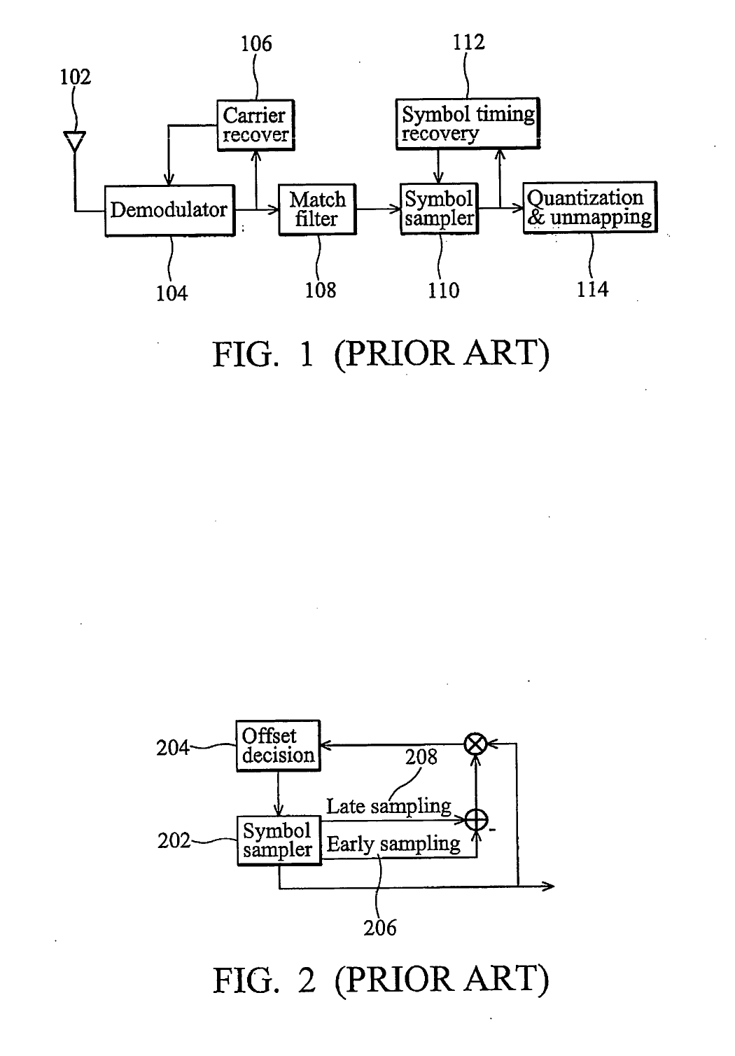

### DETAILED DESCRIPTION OF THE INVENTION

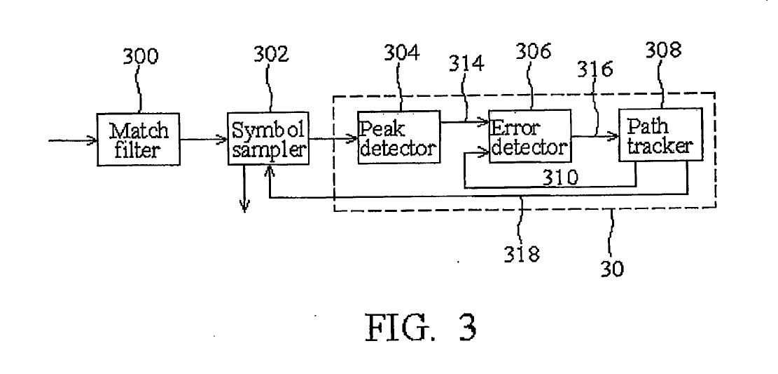

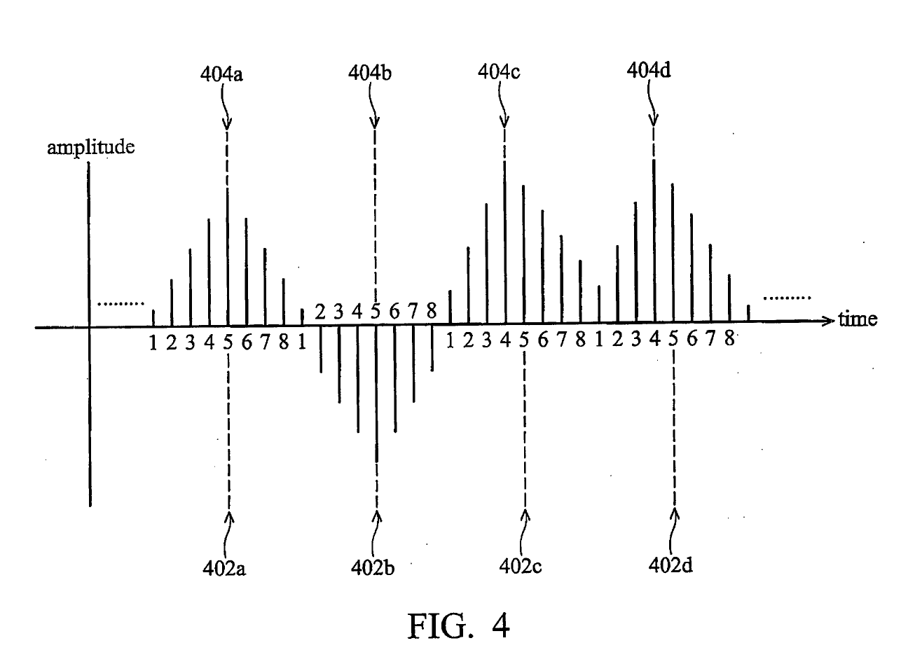

FIG. 3 is a block diagram showing an embodiment of the signal path tracking system disclosed in the present invention. The signal path tracking system is an alternative for the conventional delay lock loop (DLL). The purpose of the signal path tracking system 30 is to adjust the timing scheme of the symbol sampler 302, in order to establish on-time samples at the optimal points. The symbol sampler 302 samples the output of a match filter 300 at a preset sampling rate. This sampling rate takes a desired number of samples per symbol according to the frequency of the received signal. In FIG. 4, the signal-time diagram shows a signal sampled at a sampling rate of 8 samples per symbol. As mentioned before, the match filter 300 generates a peak signal during each symbol duration, the optimal point. The symbol sampler establishes an on-time sample for each symbol according to the timing scheme, with the on-time sample examined to determine the original symbol in the later stages of the receiving method, such that the on-time samples must be precise enough to recover the original symbols. Taking the on-time samples at optimal points is an effective approach to increase accuracy.

First Embodiment

As shown in FIG. 3, a peak detector 304 determines the time of the peak signal in each symbol, creating optimal point 314, received by an error detector 306, along with current sampling point 310 from a path tracker 308. The symbol sampler 302 updates its timing scheme according to an output 318 of the path tracker 308. Details of these functional blocks are described in the following.

Current sampling points 402a˜402d of FIG. 4 correspond to points at which symbol sampler 302 of FIG. 3 samples the on-time sample for each symbol. In FIG. 4, the current sampling points 402a-402d mark acquisition of the fifth samples of the symbols. After obtaining an on-time sample, the symbol sampler 302 simply takes another 8 samples to establish the next on-time sample for a subsequent symbol.

Due to channel imperfection, interference from other signals, or other possible causes, the timing scheme of the receiver has difficulty synchronizing with the received signal after a period of time. Thus the receiver must perform signal path tracking to adjust the timing scheme to recover the synchronization periodically. The example given in FIG. 4 shows that although peak amplitudes are set to be sampled at current sampling points 402a˜402d, actual peaks occur at 404a˜404d, points not always aligned with the current sampling points 402a˜402d, defined as optimal points. In FIG. 4, the optimal points 404c and 404d correspond with the fourth samples, different from the current sampling points 402c and 402d. In this example, the peak value of each symbol gradually shifts from the fifth sample to the fourth sample, which implies that timing of the receiver may be required to align with the receiving signal. A symbol timing recovery system is required to modify the timing scheme periodically to synchronize the optimal points for subsequent symbols.

A peak detector 304 in FIG. 3 receives samples from the symbol sampler 302, and then detects the time of peak signal strength (optimal points 314) in each symbol duration. An error detector 306 error checks once every N symbols. The error detector 306 receives N optimal points 314 from the peak detector 304 and N current sampling point 310 from the path tracker 308.

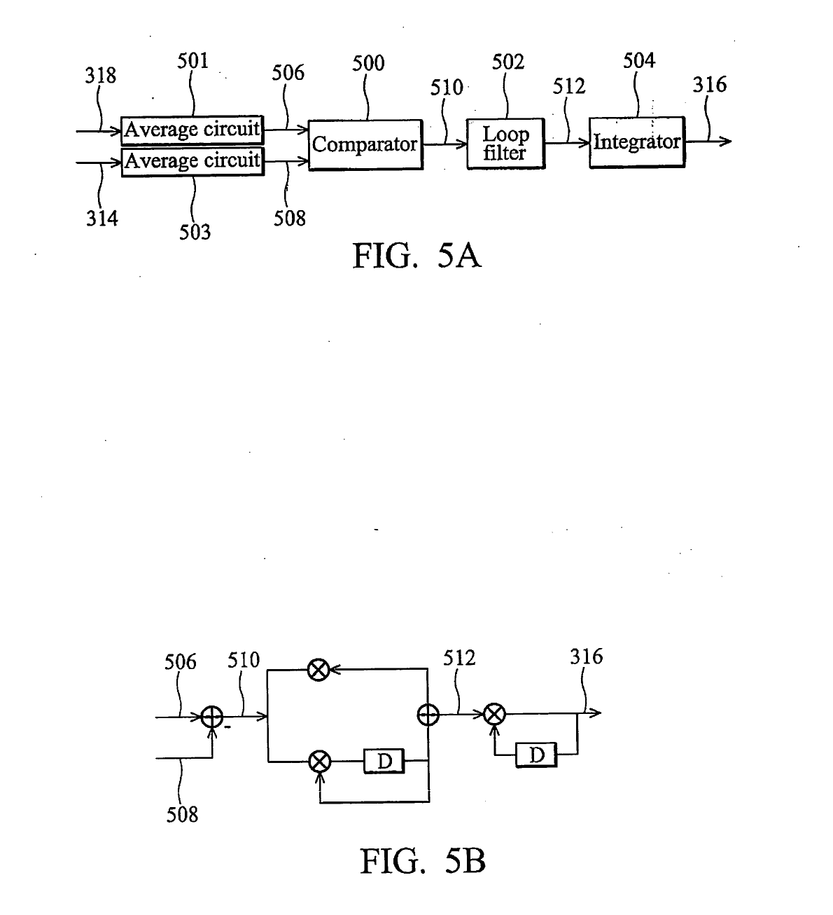

FIG. 5A is a simple block diagram showing three functional blocks in the error detector 306. FIG. 5B is a more detailed diagram showing logic circuits of the three functional blocks in FIG. 5A. If N symbols are located in a slot and the error detector computes an output when receiving a complete slot of symbols, when the error detector processes slot k, it must receive N current sampling points xᵣₑₐₗ(n) 310 generated according to the current timing scheme, used for sampling symbols in slot k. The error detector also receives N optimal points xₒₚₜ(n) 314 found by detecting the peak value in each symbol of slot k, where n=0˜N. First, an average sampling trace XRₖ is determined by averaging N xᵣₑₐₗ in slot k, and an average optimal trace XOₖ is also determined in a similar manner, as shown in equations (1) and (2).

$$\begin{matrix}{XR}_{k} = {\sum }_{n = 1}^{N} {x}_{real} ( n ) / N & ( 1 ) \\ {XO}_{k} = {\sum }_{n = 1}^{N} {x}_{opt} ( n ) / N & ( 2 )\end{matrix}$$

These average operations are performed by the two average circuits 501 and 503. XRₖ 506 and XOₖ 508 then feed to a comparator 500 to execute the following equation.
Eₖ=XRₖ−XOₖ (3)

The difference between the two inputs 506 and 508 is an error Eₖ 510, which indicates the validity of current on-time sampling. The signal path tracking system seeks to minimize this error 510 for the next slot. A loop filter 502 receives Eₖ 510 and the loop filter 502 stores at least one error from an earlier slot, for example, Eₖ₋₁. By extrapolation algorithm or other similar mathematical estimation, Eₖ and Eₖ₋₁ can be used to predict an expected error EEk+1 at the end of slot k+1, or an average moving error eek+1 contributed per symbol in slot k+1. Such extrapolation can be performed by convolution in the loop filter 502 as shown in equation (4),
eeₖ₊₁=EEₖ₊₁/N=(Eₖ,Eₖ₋₁,Eₖ₋₂, . . . ) [symbol] F(s) (4)
where F(s) represents a loop filter with coefficients. As shown in FIG. 5B, the loop filter 502 has two convolution operators and a delay register which accumulates precedent values and computes the average moving error eeₖ₊₁ 512. eeₖ₊₁ 512 indicates an average rate of change of the input 510. This expected error EEₖ₊₁ or average moving error eeₖ₊₁ should be used to adjust the current timing scheme, in order to minimize Eₖ₊₁ in the next slot (slot k+1). In the next slot, xᵣₑₐₗ(n) calculated from the adjusted timing scheme will hence be n*eeₖ₊₁ ahead of the xᵣₑₐₗ(n) calculated from the unadjusted time scheme after adjustment.
xᵣₑₐₗ(n)=init_{—}addr−∫eeₖ₊₁dt=init_{—}addr−n*EEₖ₊₁/N (5)
init_addr in equation (5) represents xᵣₑₐₗ(n) calculated from the unadjusted timing scheme for slot k+1. In FIG. 5A, the loop filter 502 passes the average moving error 512 to an integrator 504. The integrator 504 computes expected errors 316 according to the average moving error 512 to correct future sampling points for the next N symbols.

Still in FIG. 3, the expected errors 316 for estimating the sampling points of the next N symbols discussed before are the input of a path tracker 308. The path tracker 308 computes the current sampling points 310 and 318 according to the expected errors 316. The symbol sampler 302 receives the sampling points 318 as feedback for symbol timing recovery. This feedback action adjusts the timing scheme of the symbol sampler 302, thereby recovering the synchronization between the receiver and the receiving signal.

Second Embodiment

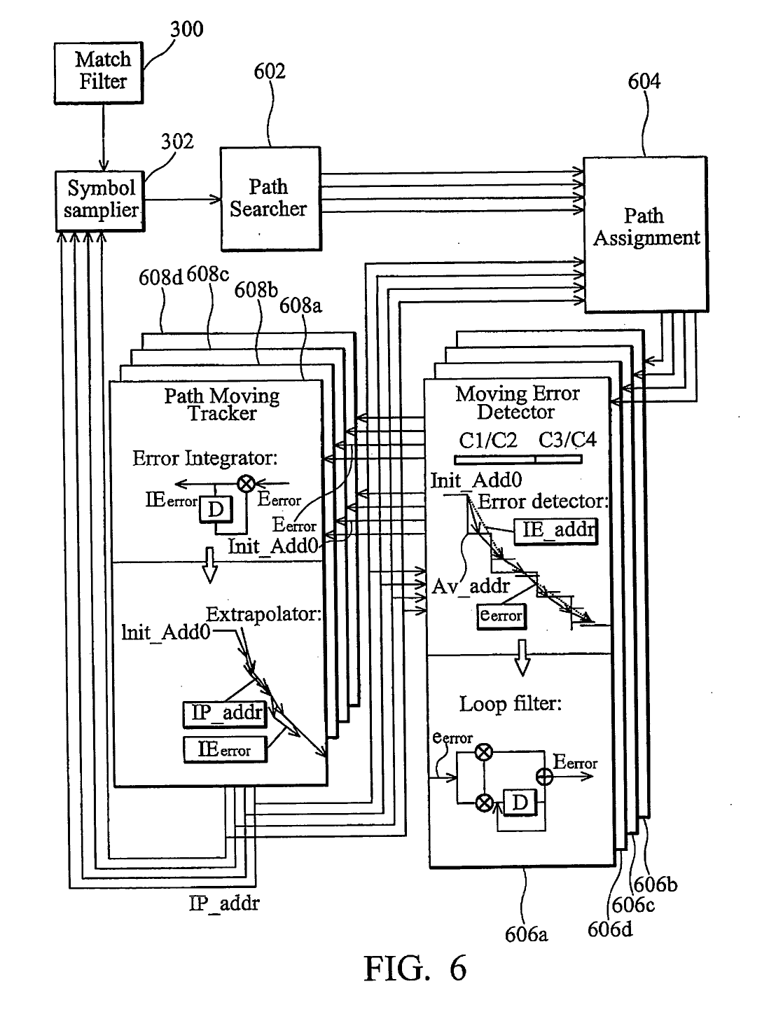

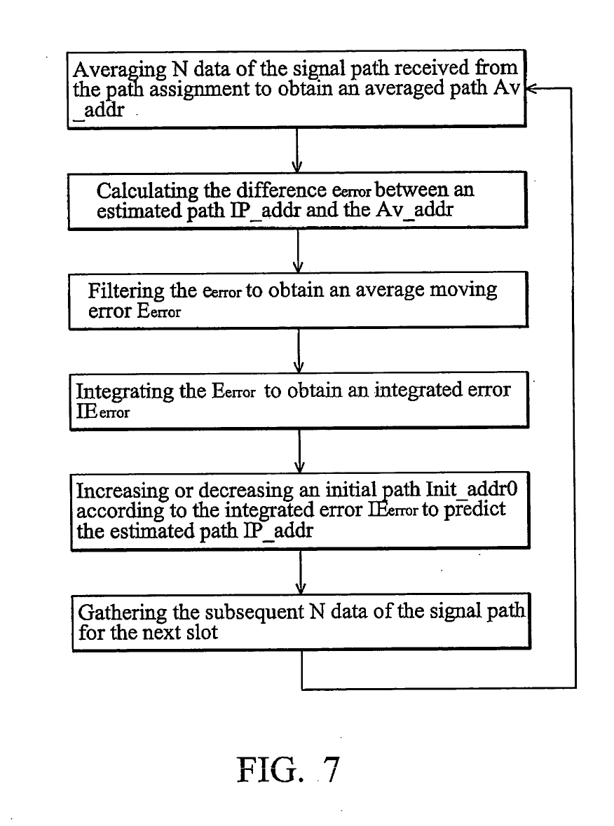

FIG. 6 is a block diagram illustrating a second embodiment of the signal path tracking system of the present invention. The second embodiment can be implemented in a RAKE receiver for the CDMA system. Instead of a single signal, a cluster of signals is received by the match filter 300 of the receiver. The match filter 300 then inputs the matched signals into the symbol sampler 302. The match filter 300 and the symbol sampler 302 of the second embodiment are identical to the first embodiment. The output of the symbol sampler 302 is connected to an input of a path searcher 602. The path searcher 602 identifies the sampled signals, and forwards the sampled signals to a path assignment 604. The path assignment acts like a multiplexer, which separates the sampled signals, then forwards each of the predetermined k sets of signal path to a corresponding moving error detector 606 (referred as ‘finger’ in a RAKE receiver). FIG. 6 shows a case of receiving four independent signal paths (K=4), hence four moving error detectors 606a˜606d and four path moving trackers 608a˜608d are used. FIG. 7 is a flowchart describing the process of the moving error detector 606 and the path moving tracker 608. Each of the moving error detector 606 averages N data of the signal path received from the path assignment 604 to obtain an averaged path Av_addr. The moving error detector 606 then calculates an average moving error Eₑᵣᵣₒᵣ by filtering the difference eₑᵣᵣₒᵣ between the averaged path Av_addr and an estimated path IP_addr. Each of the moving error detector 606 passes the average moving error Eₑᵣᵣₒᵣ and an initial path Init_Add0 to a corresponding path moving tracker 608. Each of the path moving tracker 608 integrates the average moving error Eₑᵣᵣₒᵣ to obtain an integrated error IEₑᵣᵣₒᵣ, and modifies the initial path Init_Add0 according to the integrated error IEₑᵣᵣₒᵣ to obtain the estimated path IP_addr.

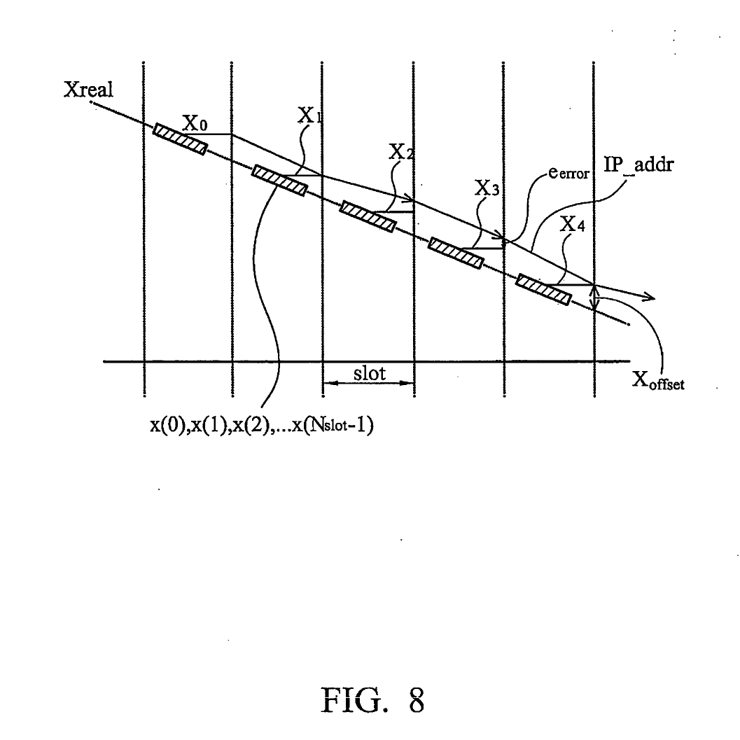

FIG. 8 is a graph illustrating the signal path tracking according to the second embodiment of the present invention. The horizontal axis of the graph represents time. The estimated path IP_addr is computed to track the signal path Xᵣₑₐₗ. The averaged path Av_addr is shown as horizontal lines in each slot, and the difference between the averaged path Av_addr and the estimated path IP_addr is eₑᵣᵣₒᵣ. However, there is still an offset X_{offset} between the signal path Xᵣₑₐₗ and the estimated path IP_addr. This offset could be reduced by increasing the complexity of the hardware and the processing speed of the central processor.

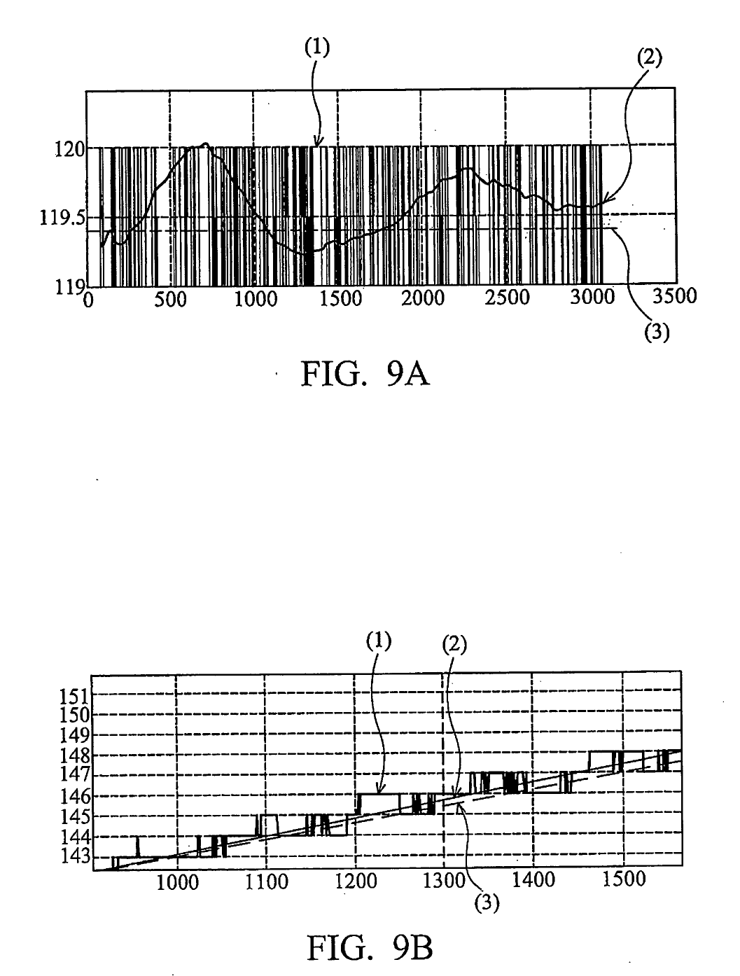

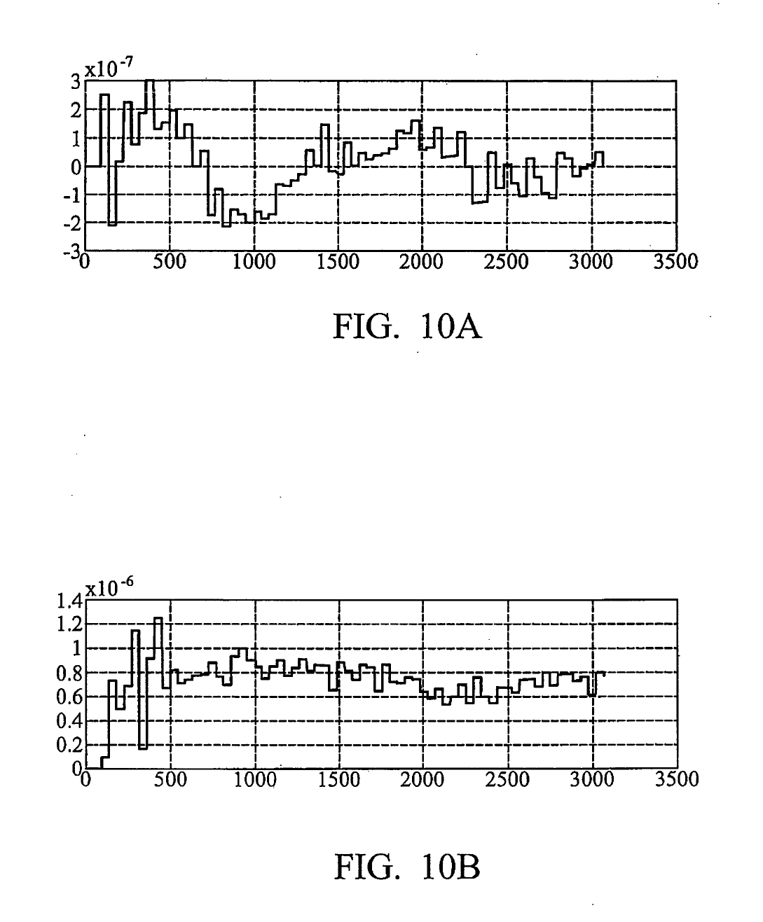

FIGS. 9˜12 are simulation results of signal path tracking with a chip rate of 3.84 MHz, and a sampling rate of four times the chip rate (15.36 MHz). In FIG. 9A, curve (1) represents a static signal after sampling, curve (2) represents the estimated path (IP_addr) of the static signal computed by the signal path tracking method of the present invention, and curve (3) represents the real path (Xᵣₑₐₗ) of the static signal. In FIG. 9B, curve (1) represents a dynamic signal after sampling, curve (2) represents the estimated path (IP_addr) of the dynamic signal computed by the signal path tracking method of the present invention, and curve (3) represents the real real path (Xᵣₑₐₗ) of the dynamic signal. The dynamic signal has an average moving error of 7 ppm. The curve in FIG. 10A shows the average moving error of the static signal in FIG. 9A. The curve in FIG. 10B shows the average moving error of the dynamic signal in FIG. 9B.

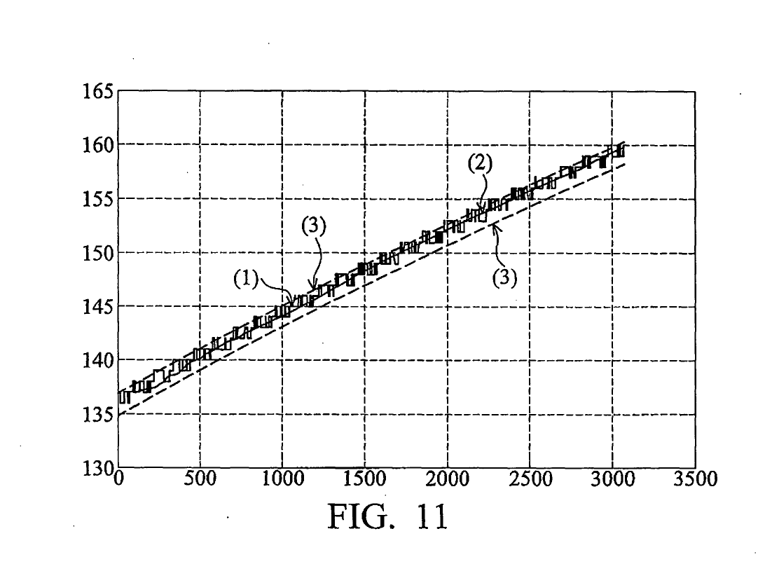

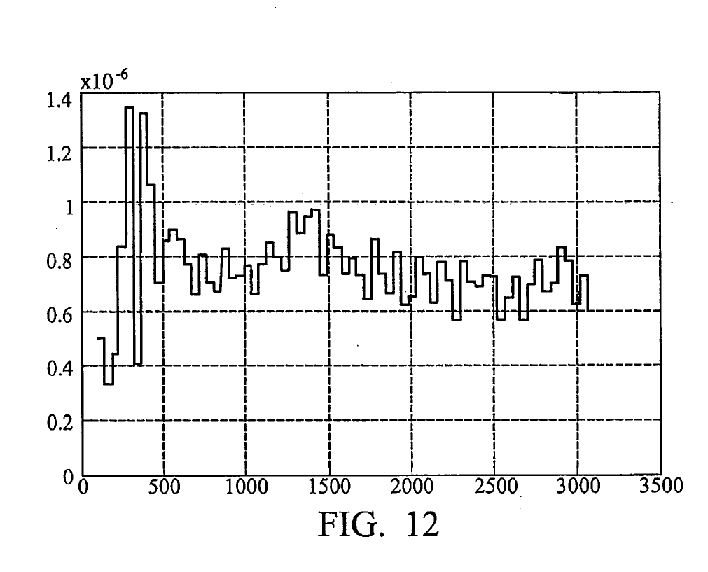

Simulation results in FIGS. 11 and 12 prove that the signal path tracking method of the present invention is also capable of tracking the path of a cluster of signals. In FIG. 11, curve (1) represents the path of two dynamic signals (path 1, path 2), curve (2) represents the estimated path (IP_addr) of the two dynamic signals computed by the signal path tracking method of the present invention, and curve (3) represents the real path (Xᵣₑₐₗ) of the two dynamic signals (path 1, path 2). The two dynamic signals both have an average moving error of 7 ppm, and the paths of the two dynamic signals are only two-sample apart. The curve in FIG. 12 shows the average moving error of the clustered path.

The present invention provides a method of signal path tracking for symbol timing recovery using extrapolation, predicting outer data by two or more true measurements. In comparison with the DLL system, the symbol timing recovery system of the present invention detects the optimal points for sampling the on-time sample and compares them with the current sampling points. The system then adjusts the timing scheme for subsequent symbols according to the average moving error of the timing differences. The DLL system, on the other hand, detects timing error by comparing a sample before and after the on-time sample, then modifying the timing scheme if the difference between these two samples exceeds a preset threshold.

The method disclosed in the present invention is capable of tracking a cluster of signals in a complicated channel, for example a CDMA channel. The signal tracking system of the present invention can be implemented in a RAKE receiver for receiving CDMA signals.

Finally, while the invention has been described by way of example and in terms of the above, it is to be understood that the invention is not limited to the disclosed embodiment. On the contrary, it is intended to cover various modifications and similar arrangements as would be apparent to those skilled in the art. Therefore, the scope of the appended claims should be accorded the broadest interpretation so as to encompass all such modifications and similar arrangements.

1. A method of signal path tracking for symbol timing recovery in a receiver, comprising the steps of:
providing current sampling points for a received signal to generate current symbols according to a timing scheme;
detecting optimal points of the current symbols for sampling the received signal;
computing an expected error from the current sampling points and the optimal points; and
adjusting the timing scheme to generate a future sampling point for a subsequent symbol according to the expected error, thereby recovering symbol timing of the receiver.

2. The method according to claim 1, wherein computing the expected error further comprises:
comparing the current sampling points with the optimal points to obtain timing differences;
filtering the timing differences to obtain an average moving error; and
integrating the average moving error to obtain the expected error.

3. The method according to claim 2, wherein filtering the timing differences further comprises convolution and accumulation of the timing differences.

4. The method according to claim 1, wherein the optimal points for sampling the received signal correspond with samplings of a maximum signal strength in each symbol duration.

5. The method according to claim 1, wherein computation of the expected error occurs once every N symbols, and the current sampling points and the optimal points for computing the expected error are averages of the N current symbols.

6. The method according to claim 1, wherein the timing scheme for sampling the received signal is adjusted to continue alignment of a sampling clock transition with an optimal sampling point computed by the expected error of a preceding symbol.

7. A system of signal path tracking for symbol timing recovery in a receiver comprising:
a symbol sampler, sampling a received signal at current sampling point according to a timing scheme;
a peak detector, detecting optimal points for sampling the received signal;
an error detector, computing an expected error from the optimal points detected by the peak detector and the current sampling points of the symbol sampler; and
a path tracker, computing a future sampling point of a subsequent symbol and providing the future sampling point to the symbol sampler to adjust the timing scheme.

8. The system for symbol timing recovery according to claim 7, the error detector further comprising:
a comparator, comparing the current sampling points of the symbol sampler and the optimal points detected by the peak detector to obtain timing differences;
a loop filter, filtering the timing differences received from the comparator to obtain an average moving error; and
an integrator, integrating the average moving error from the loop filter to obtain an expected error.

9. The system for symbol timing recovery according to claim 7, wherein the optimal points for sampling the received signal correspond with samplings of a maximum signal strength in each symbol duration.

10. The system for symbol timing recovery according to claim 7, wherein the error detector computes the expected error once every N symbols, and the current sampling points and the optimal points for computing the expected error are averages of N symbols.
